(19) United States
(12) Patent Application Publication
(10) Pub. No.: US 2026/0105885 A1
(43) Pub. Date: Apr. 16, 2026

(54) CONTROL LOGIC AND HARDWARE MECHANISM FOR BURN-IN COMPENSATION

(71) Applicant: Google LLC, Mountain View, CA (US)

(72) Inventors: Yu-Quan Chen, New Taipei City (TW); Jyothi Karri, San Jose, CA (US); Bang-Sian Liu, Hsinchu County (TW)

(21) Appl. No.: 19/355,165

(22) Filed: Oct. 10, 2025

Related U.S. Application Data
(60) Provisional application No. 63/707,144, filed on Oct. 14, 2024.

(51) Int. Cl. G09G 3/3208

(52) U.S. Cl. CPC G09G 3/3208; G09G 2320/0242; G09G 2320/0257; G09G 2320/045; G09G 2320/046; G09G 2330/10

(57) ABSTRACT

Methods and systems, including computer-readable media, are described for hardware system and control logic for implementing burn-in compensation on a display of a computing device. The system generates display data that includes pixel values used to render content on a display of the device. The system detects a region of interest on the display using the pixel values of the display data and identifies a burn-in indicator value from a look-up-table (“LUT”) of normalized values for the region of interest on the display. Correction coefficients are determined for the region of interest based on the burn-in indicator value for the region of interest. The system computes compensation control values using the correction coefficients and the burn-in indicator value and implements burn-in compensation on the display based on the compensation control values.

### CROSS-REFERENCE TO RELATED APPLICATIONS

This disclosure claims the benefit of U.S. Provisional Patent Application No. 63/707,144, filed on Oct. 14, 2024, which is incorporated herein by reference in its entirety

### TECHNICAL FIELD

This specification generally relates to hardware displays for a computing device.

### BACKGROUND

This specification generally relates to hardware displays for a computing device.

Computing devices, such as smartphones, televisions, computer monitors, and tablets, include hardware displays that use various digital display technologies to present imagery and other content as outputs rendered on the display. For example, a light-emitting diode (LED) or an organic LED (OLED) display is a type of display technology that is often used to integrate digital (or/electronic) displays in example computing devices and related consumer electronics.

These modern hardware displays include de-burn-in features and related compensation circuitry to protect against occurrences of burn-in that degrade the rendering functionality of the display. For example, an OLED compensation cycle is at least one function that is used to adjust pixel values of an OLED display to achieve a particular brightness and luminance. The compensation cycles are tuned to prevent image retention (e.g., image “burn in”), which can occur as a result of OLED luminance and color degradation in the hardware display of a computing device.

In general, these burn-in effects often manifest as “ghost” afterimages that are retained on the display screen due to pixel luminance efficiency degradation following extended use of the OLED panel integrated in the electronic display. Thus, burn-in compensation has been a common concern among prospective OLED display manufacturers.

### SUMMARY

This specification describes an efficient burn-in compensation (or de-burn-in) technique to mitigate or preclude occurrences of temporary image retention resulting from degraded pixels of a digital display. The technique adapts aspects of burn-in compensation cycles for implementation on a System-on-Chip (SoC) of computing device, rather than at a display-driven integrated circuit (DDIC) of an LED or OLED display of that computing device. The technique leverages integrated hardware circuitry and other resources on the SoC of a computing device (e.g., a smartphone) to implement a hardware efficient burn-in compensation framework, without requiring additional or extraneous circuitry in the hardware display.

More specifically, the techniques include control logic and a corresponding hardware mechanism that are configured to collect display utilization data, use the display data to compute compensation values, and generate control outputs to counteract burn-in effects based on the computed compensation values. Aspects (or all) of the control logic can be integrated in the hardware mechanism, which is implemented as dedicated burn-in compensation hardware and included along a display processing pipeline of the SoC. For example, the dedicated burn-in compensation hardware can be incorporated along a processing pipeline of a display processing unit (DPU) of the SoC.

The hardware mechanism generates display data that includes pixel values used to render content on a digital display of a computing device. The mechanism detects a region of interest on the display using the pixel values of the display data and identifies a burn-in indicator value from a look-up-table (“LUT”) of normalized values for the region of interest on the display. The burn-in compensation hardware (e.g., the hardware mechanism) determines correction coefficients for the region of interest based on the burn-in indicator value for the region of interest.

The control logic integrated in the burn-in compensation hardware is configured to compute compensation control values using the correction coefficients and the burn-in indicator value. The control logic is further configured to implement (or initiate) burn-in compensation on the display based on the compensation control values that are computed from the correction coefficients and burn-in indicator value.

An innovative aspect of the subject matter described in this specification can be embodied in a method implemented using a hardware burn-in compensation mechanism on a System-on-Chip (“SoC”) of a computing device. The method includes generating display data including pixel values used to render content on a display of the computing device and detecting a region of interest on the display from the pixel values of the display data. The method further includes: i) identifying a burn-in indicator value from a look-up-table (“LUT”) of normalized values for the region of interest on the display and ii) determining a correction coefficient for the region of interest based on the burn-in indicator value for the region of interest. The method also includes: i) computing compensation control values using the correction coefficient and the burn-in indicator value, and ii) applying the compensation control values to implement burn-in compensation on the display of the computing device.

Identifying a burn-in indicator value can include, for the region of interest, identifying a respective burn-in indicator value for each color channel in an R, G, B color channel of the region. In some implementations, determining a correction coefficient includes: for the region of interest: determining a respective correction coefficient for each color channel in the R, G, B color channel of the region is based on the respective burn-in indicator value identified for the corresponding color channel in the R, G, B color channel of the region. In some other implementations, computing compensation control values includes: for the region of interest, computing compensation control values for each color channel in the R, G, B color channel of the region based on the: i) respective burn-in indicator value identified for the corresponding color channel in the R, G, B color channel of the region, and ii) the respective correction coefficient determined for the corresponding color channel in the R, G, B color channel of the region.

The hardware burn-in compensation mechanism is represented by a portion of hardware circuitry on an integrated circuit of a display processing unit along a display processing pipeline on the SoC. In some implementations, the burn-in indicator value quantifies a degree of burn-in effect at a particular position within the region of interest on the display. In some other implementations, the burn-in indicator indicates a relative severity of pixel degradation for a pixel at the particular position within the region of interest on the display.

Generating display data can include: generating display data based on accumulations of pixel luminance and brightness values obtained over a predefined time duration. In some implementations, detecting a region of interest on the display can include: detecting a region of interest on the display from pixel values that are determined as a function of a respective luminance of each pixel and a corresponding temperature at an area of the display that includes each pixel.

Another aspect of the subject matter described in this specification can be embodied in a System-on-Chip (“SoC”) for a computing device. The SoC includes a hardware burn-in compensation mechanism; a processing device; and a non-transitory machine-readable storage device storing instructions that are executable by the processing device to cause performance of operations. The operations include generating display data including pixel values used to render content on a display of the computing device and detecting a region of interest on the display from the pixel values of the display data. The method further includes: i) identifying a burn-in indicator value from a look-up-table (“LUT”) of normalized values for the region of interest on the display and ii) determining a correction coefficient for the region of interest based on the burn-in indicator value for the region of interest. The method also includes: i) computing compensation control values using the correction coefficient and the burn-in indicator value, and ii) applying the compensation control values to implement burn-in compensation on the display of the computing device.

Another aspect of the subject matter described in this specification can be embodied in a non-transitory machine-readable storage device storing instructions for implementing display operations using a hardware burn-in compensation mechanism on a System-on-Chip (“SoC”) of a computing device. The instructions are executable by a processing device to cause performance of operations including generating display data including pixel values used to render content on a display of the computing device and detecting a region of interest on the display from the pixel values of the display data. The method further includes: i) identifying a burn-in indicator value from a look-up-table (“LUT”) of normalized values for the region of interest on the display and ii) determining a correction coefficient for the region of interest based on the burn-in indicator value for the region of interest. The method also includes: i) computing compensation control values using the correction coefficient and the burn-in indicator value, and ii) applying the compensation control values to implement burn-in compensation on the display of the computing device.

Other implementations of this and other aspects include corresponding systems, apparatus, and computer programs, configured to perform the actions of the methods, encoded on computer storage devices. A system of one or more computers or processing devices can be so configured by virtue of software, firmware, hardware, or a combination of them installed on the system that in operation causes the system to perform the actions. One or more computer programs can be so configured by virtue of having instructions that, when executed by a data processing apparatus, cause the apparatus to perform the actions.

The subject matter described in this specification can be implemented in particular embodiments to realize one or more of the following advantages.

As noted above, the disclosed burn-in compensation techniques leverage integrated hardware circuitry and other SoC resources of a computing device (e.g., a smartphone) to implement burn-in mitigation in a hardware efficient manner, e.g., without requiring a DDIC or other additional, extraneous circuitry in the hardware display. More specifically, the disclosed techniques offload burn-in compensation from a DDIC to dedicated hardware resources of the SoC, which results in lower hardware costs for comparable (or even better) results. Additionally, removing burn-in compensation from the DDIC removes dependency on third-party DDIC vendors and reduces manufacturing costs.

Further, using a LUT-based calculation reduces the data footprint required to perform burn-in compensation and/or mitigation. For example, a display panel can be divided into multiple tiles (e.g., a pixel-based tile), where each tile is a subset of pixels that each represent a unit of illumination on a digital display. The disclosed burn-in compensation technique can use a 1D (or single) LUT value to perform burn-in mitigation for a given tile. This efficient approach to mitigating burn-in requires fewer resources and translates to improved efficiency over legacy techniques that require multiple instances of data for de-burn-in operations.

Thus, the LUT-based calculation is a streamlined framework for generating burn-in compensation control values for different tile segments of a digital display. The approach also provides for reductions in data values, memory resources, and computational requirements for performing burn-in compensation. Relative to prior approaches, these improved techniques for burn-in compensation result in processing efficiencies that reduce overall power consumption and leads to battery savings in the related device.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example computing system that includes control logic and related hardware mechanisms for burn-in compensation.

FIG. 2 shows an example hardware mechanism for burn-in compensation.

FIG. 3 shows example control logic for computing compensation control values to implement burn-in compensation.

FIG. 4 shows an example framework for obtaining pixel values used to render content on a display of a computing device.

FIG. 5 shows an example segmentation framework for computing compensation control values to implement burn-in compensation.

FIG. 6 shows example regions of a display that can be identified for burn-in compensation.

FIG. 7 is an example process for executing burn-in compensation on a display of a computing device.

Like reference numbers and designations in the various drawings indicate like elements.

### DETAILED DESCRIPTION

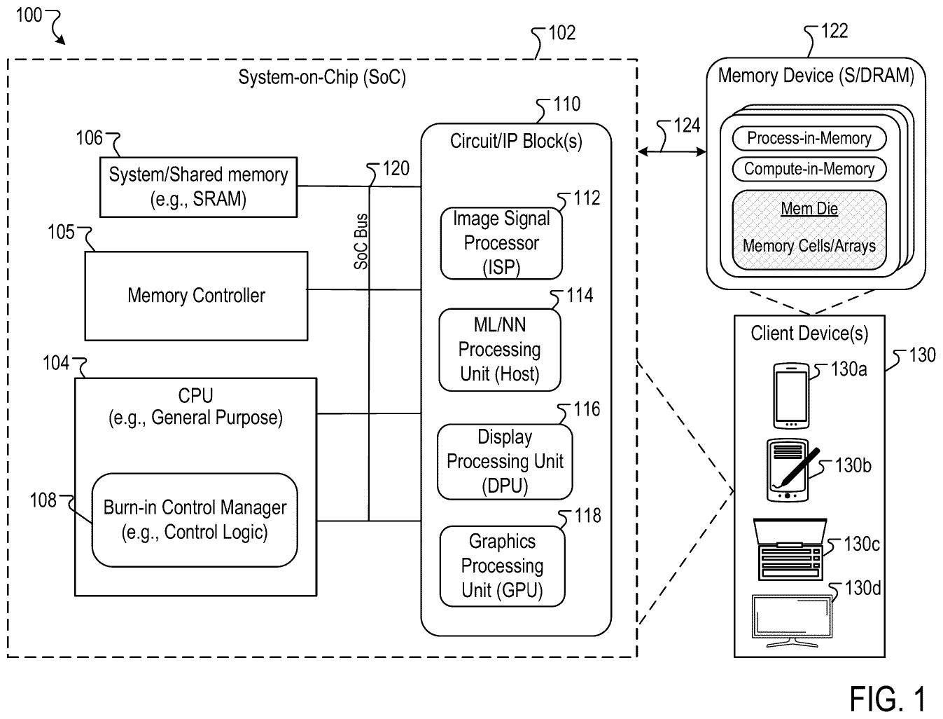

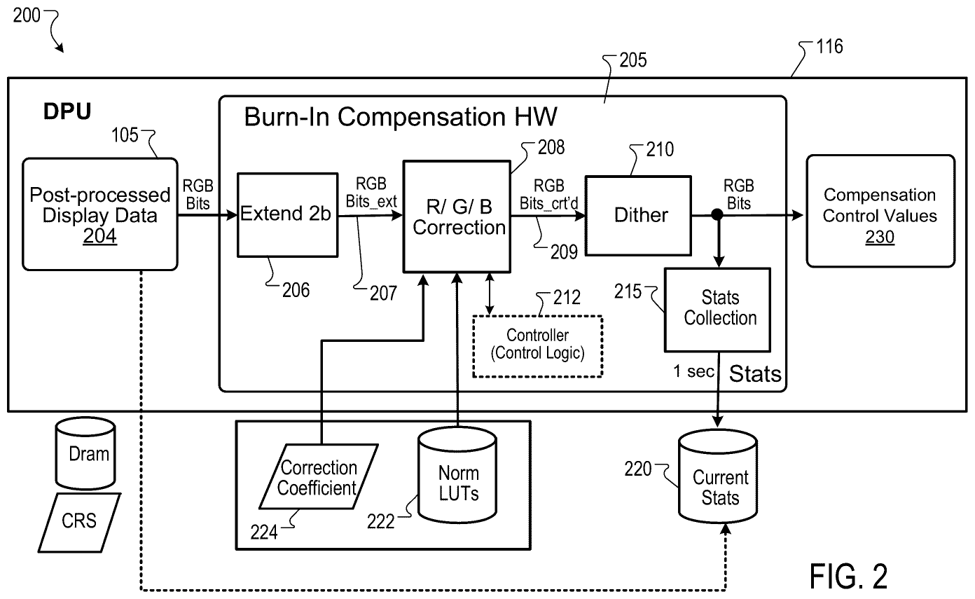

FIG. 1 is a block diagram of an example computing system 100 that includes control logic and related hardware mechanisms for burn-in compensation. In the example of FIG. 1 the computing system 100 includes a system-on-chip 102 (“SoC 102”). The SoC 102 includes a central processing unit 104 (“CPU 104”), a memory controller 105, a shared memory 106 (“memory 106”), a burn-in control manager 108, and an IP/circuit block 110. In some implementations, system 100 can include multiple SoCs and any descriptions for the SoC 102 will apply equally to each of the multiple SoCs that may be included at system 100. Similarly, system 100 can include multiple burn-in compensation blocks corresponding to burn-in control manager 108 as well as the hardware mechanisms for burn-in compensation that are described in detail below with reference to the example of FIG. 2.

The CPU 104 can be a general-purpose CPU (e.g., a single or multi-core CPU). The CPU 104 generates one or more indicators, such as an app-launch indicator or a function call that is triggered in response to executing or launching an application at a user device. For example, the application can be a camera application that uses an imaging sensor to generate image data or a gaming application that requires substantial memory and graphics processing resources to render graphical content of the game. The CPU 104 also generates one or more application values, such as pixel values or frame rate. The application values may be associated with a function call, may be descriptive of an event that occurs during execution of the application, or both.

The memory 106 is a system memory, shared memory, or both. In the example of FIG. 1, memory 106 is depicted external to circuit block 110. However, memory 106 can include portions of memory that are: i) specific to circuit block 110, ii) external to circuit block 110, or iii) both. The memory 106 can be random access memory of the SoC 102, such as static random-access memory (SRAM), dynamic random-access memory (DRAM), a synchronous DRAM (SDRAM), or double data rate (DDR) SDRAM.

In some implementations, aspects of memory 106 are configured as a shared scratchpad memory that supports parallel access of its memory resources by two or more processors of the circuit 110. The memory 106 can also include various other types of memory, such as high bandwidth memory (HBM), narrow memory (e.g., for storing 8-bit values), wide memory (e.g., for storing 16-bit or 32-bit values), etc.

The resource manager 108 is implemented in hardware and software. Aspects of the resource manager 108 can be also implemented as firmware of the SoC 102 or firmware of a device of the SoC 102, such as a DRAM memory device or the CPU 104. The resource manager 108 is a burn-in control resource manager that includes control logic implemented in hardware, software, or both. For example, the burn-in control manager 108 can include resources such as flip-flops, registers, buffers, etc. that are implemented in hardware and control logic (e.g., programmed code) that is implemented in software.

The circuit block 110 generally includes individual IP devices such as processors, processor cores, or special-purpose processing devices. For example, the circuit block 110 can include an image signal processor (ISP) 112, a host (or special purpose) processing unit (HPU) 114, a display processing unit (DPU) 116, and a graphics processing unit (GPU) 118. The circuit block 110 is referred to alternatively as an IP block 110, where the IP block can include one or more proprietary hardware elements. For example, each of the ISP 112, HPU 114, DPU 116, and GPU 118 can be a respective proprietary IP block (or IP device) of a particular entity or device manufacturer.

One or more aspects of the burn-in control manager 108 can be implemented as a software routine (or module) of the CPU 104, which uses one or more hardware resources of the CPU 104, such as registers, buffers, etc. The CPU 104 can be configured as an instruction and vector data processing engine that processes data obtained from a system memory of the SoC 102, such as memory 106. In some implementations, each processor (e.g., ISP 112, DPU 116, HPU 114, GPU 118) of the SoC 102 includes multiple cores and the CPU 104 and/or the burn-in control manager 108 can generate control signaling 124 to manage and distribute compute operations for generating compensation control values to a memory device 122 (e.g., DRAM) to minimize the processing load at a core(s) of the DPU 116. The control signaling 124 is routed at system 100 using an example bus 120 of the SoC 102. The control signaling 124 can include commands, requests, data, instructions, or combination of these.

The burn-in control manager 108 cooperates with the CPU 104, memory controller 105, and/or host processor to dynamically control and manage one or more compute-in-memory (CiM) operations. In some implementations, the CiM operations are executed at the SoC 102 in support of a heterogeneous burn-in compensation operations between the DPU 116 and at least one other processing unit of the IP block 110, the CPU 104, or both. More specifically, the burn-in control manager 108 is configured to generate control signaling 124 and use one or more discrete signal values of the control signaling 124 to initiate and manage burn-in compensation operations at the DPU 116, the memory device 122, or both.

The system 100 includes an example memory device 122. The memory device 122 can include multiple memory dies. For example, the memory device 122 can include N memory die, where N is an integer greater than 1. The memory device 122 can be a dynamic random-access memory (DRAM) or Double Data Rate (DDR) synchronous DRAM (SDRAM). The memory device 122 is configured to perform or support various types of PiM operations, CiM operations, and memory-near-computing operations (“MnC operations”). The memory device 122 performs or supports these operations using data processing resources and/or compute elements of its PiM architecture.

The SoC 102 cooperates with the memory device 122 to perform computations across one or more bank groups of the memory device 122. The computations can be for operations or workloads that involve DPU 116 at IP block 110. Additionally, the computations can be for a heterogenous operation that spans multiple processors of IP block 110, multiple IP blocks 110, or both. In at least one example the memory device 122 may be external to the SoC 102, whereas in another example the memory device 122 may be internal to the SoC 102.

In the example of FIG. 1, system 100 and the SoC 102 is an integrated circuit of an example computing device 130, which can be a consumer electronic device or mobile device, and can be represented by items such as a smartphone 130a, tablet 130b, laptop 130c, television or monitor device 130d. The devices 130 may also include other items such as an eNotebook, Netbook, or any electronic device with an SoC that communicates with an integrated display of that device. In some implementations, the system 100 and the SoC 102 are integrated circuits of a desktop computer.

FIG. 2 shows an example display processing pipeline 200 that includes a display processing unit 116, which includes an example hardware mechanism 205 for burn-in compensation. The hardware mechanism 205 is described alternatively as burn-in compensation hardware 205 and includes burn-in compensation, mitigation, or preclusion functions that are implemented in software/firmware as well as hardware. The hardware mechanism 205 includes an R/G/B correction engine 208 (“correction engine 208”) and a stats collection module 215. The hardware mechanism 205 also includes (optionally) an extend 2b block 206 and dither logic 210 that are described below.

Display processing pipeline 200 receives and processes different sets of input data to generate control values that are used to implement burn-in compensation in an example display of computing device 130. For example, the hardware mechanism 205 receives respective sets of post-processed display data 204, normalized values 222, and correction coefficients 224. The hardware mechanism 205 uses integrated control logic 212 of the RGB correction engine 208 to process each of these input datasets (e.g., data 204, values 222, and coefficients 224) and generates compensation control values 230 based on the processing operations performed on the input datasets. In some implementations, the display processing unit 116 generates the post-processed display data 204 and passes the post-processed data as an input to the hardware mechanism 205.

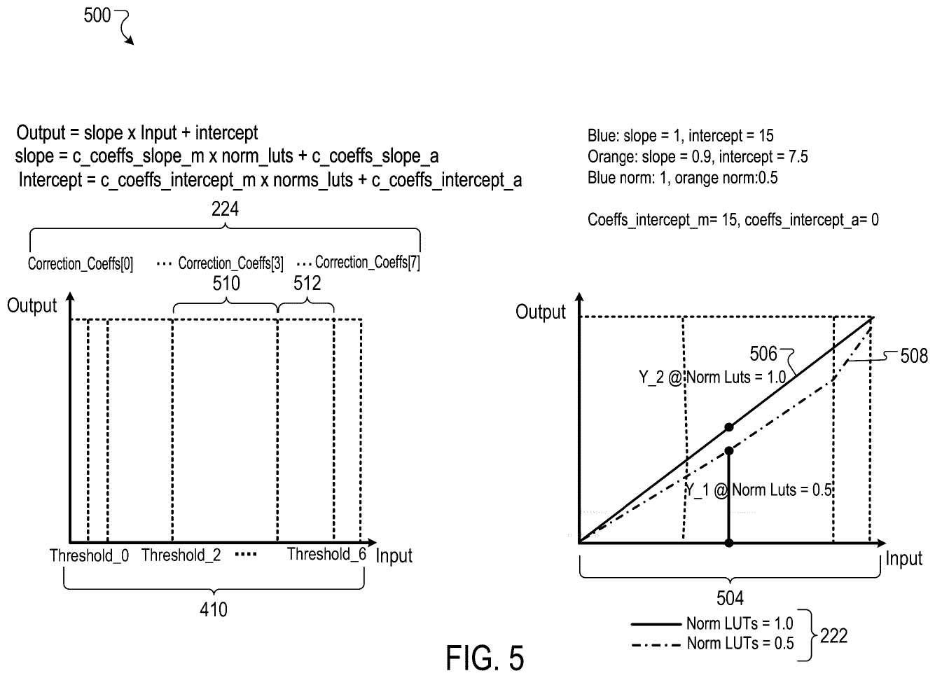

As indicated in FIG. 2, the normalized values 222 are a look-up-table (“LUT”) of normalized values for a region of interest on the display of device 130. The normalized values 222 are referred to alternatively as “norm LUTs 222” and are described in more detail below at least with reference to the example of FIG. 5. The RGB correction engine 208 can be implemented in hardware, software, or both. For example, the integrated control logic 212 of the RGB correction engine 208 can include compensation algorithms implemented in software (or firmware) and arithmetic circuitry/units that are implemented in hardware.

Burn-in compensation can begin with the collection of post-processed display data 204 that represents a current luminance value of a display integrated in device 130. In some examples, the post-processed display data 204 includes a collection of discrete values that represent a luminance value of a particular color channel on a pixel of the display, for example, Red (R) 0-255. Standard Red-Green-Blue (RGB) luminance values are an example of post-processed display data 204 (e.g., RGB (0-255, 0-255, 0-255)). The RGB luminance values for (0-255, 0-255, 0-255) can be represented as a binary value using a sequence of bits (e.g., “0” and “1”). For example, the binary value can have a bit width of at least 8 bits.

In some examples, post-processed display data 204 is retrieved in a first bit format (or bit width) and then extended to a second bit width/format to facilitate burn-in compensation operations of the hardware mechanism 205. For example, the post-processed display data 204 can be retrieved in a 10-bit format, which is then extended to 12-bits by the extend 2b component 206 for further processing by burn-in compensation hardware 205. Other bit widths/formats are also within the scope of this disclosure. In general, extend 2b component 206 is an example logic block used to apply different pre-compensation data formatting techniques to display data provided to the hardware mechanism 205. For example, the extend 2b component 206 can be configured such that other data formatting techniques are included in burn-in compensation hardware 205 based on design preferences for system 100.

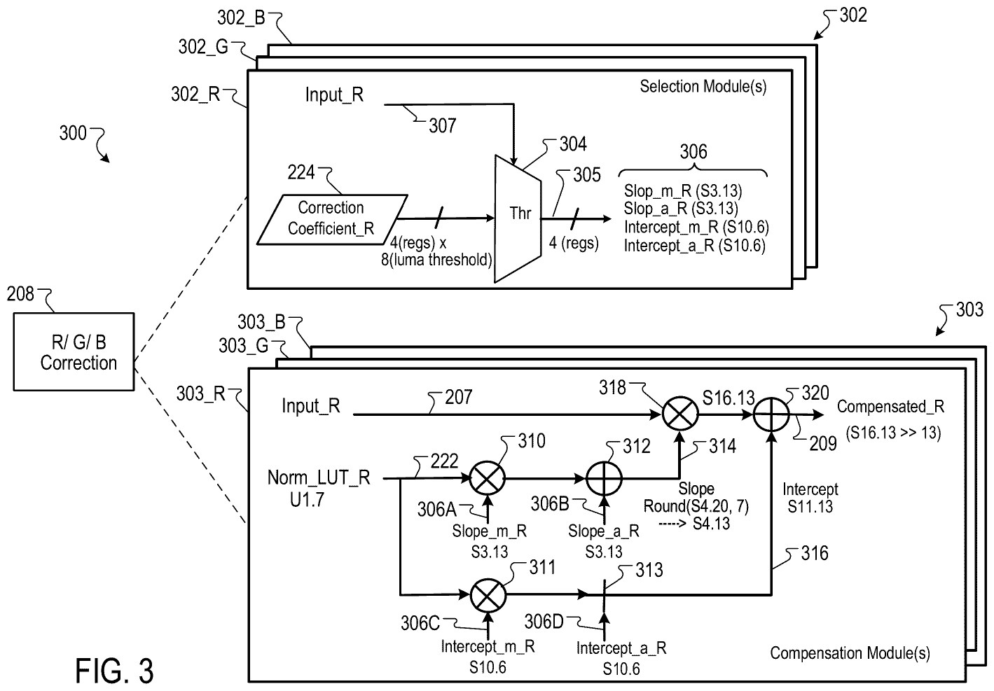

The expanded post-processed display data 207 is received by the RGB correction engine 208, which calculates and applies burn-in compensation using norm LUTs 222 and correction coefficients 224. In some examples, norm LUTs 222 are stored in DRAM (e.g., memory device 122) and passed to the hardware mechanism 205 using bus 120 of the SoC 102. For example, the norm LUTs 222 can be passed to the hardware mechanism 205 based on requests and data routings represented by control signaling 124. The correction coefficients 224 are stored in hardware control registers of system 100. The registers for storing correction coefficients 224 can be implemented along the display processing pipeline 200, for example, as a hardware feature of the hardware mechanism 205, the display processing unit 116, or both. An example detailed operation of the RGB correction coefficient 208 is explained in FIG. 3 below.

In some examples, once compensated display data 209 is produced by the RGB correction engine 208, the compensated display data 209 passes through a dither 210 that randomizes quantization noise generated by the compensation process. Although dither 210 is shown in the example hardware mechanism 200, it should be understood that any other form of noise correction or randomization can alternatively be applied as appropriate. In some examples, the dither 210 also converts the compensated display data 209 back to a 10-bit format.

Once compensated display data 209 is processed by the dither 210, it becomes compensation control values 230 which are then applied to the display. In some examples, these compensation control values 230 are also collected by the stats collection component 215 and stored as current stats 220. In some examples, current stats 220 are stored in DRAM. Current stats 220 are used as a reference point that reflects the current level of compensation applied to the display for use in subsequent burn-in compensation operations.

In the example of FIG. 2 the hardware mechanism 205 is illustrated as a component of the display processing unit 116, however, the hardware mechanism 205 can also be implemented external to the display processing unit 116, for example, as a separate, independent burn-in compensation component of the SoC 102.

FIG. 3 shows example correction logic 300 for computing compensation control values to implement burn-in compensation on a display of an example computing device 130. Correction logic 300 is implemented in a suitable component within the example hardware mechanism 205 of FIG. 2, for example, RGB correction engine 208. For case of presentation, pre- and post-compensation processing has been omitted (e.g., extend 2b 206 and dither 210). As shown in the example of FIG. 3RGB correction engine 208 includes

In some examples, correction logic 300, the selection modules 302, and compensation modules 303 cooperate to implement two processes—selection of slope & intercept values/coefficients 306 that represent correction coefficients 224 and calculation of compensation control values through application of the slope & intercept coefficients 306 to norm LUTs 222 to generate compensated display data 209. These two processes (e.g., selection and calculation/compensation) are shown separately in FIG. 3 for ease of presentation. In some implementations, the RGB correction engine 208 includes a selection module 302_R, 302_G, 302_B, for each R,G,B color channel and a compensation module 303_R, 303_G, 303_B, for each R, G, B color channel.

The RGB correction engine 208 includes a multiplexer 304, or selection mux 304, that selects between multiple input signals and forwards the selected input to an output line 305. In some implementations, multiplexer 304 is a combinational circuit that uses an unsigned 12-bit pixel input value 307 as a control signal to select a particular slope & intercept output from among multiple inputs corresponding to correction coefficients 224. In the example of FIG. 3, the multiplexer 304 is configured to select the slope & intercept values 306 from the correction coefficients 224 by using input value 307 and multiplexor 304 to apply thresholds for different regions (or intervals) of an input tile. This process can occur for each of multiple regions which, in some examples, are each stored in a different register. In some examples, two slope & intercept coefficients 306 (m_R and a_R) are generated for each of a final output slope and intercept value of compensated display data 209.

For example, a Slope_m_R value 306A and a Slope_a_R value 306B is generated from correction coefficients 224. In this example, the Slope_m_R value 306A is first multiplied 310 with the norm LUT 222. The Slope_a_R value 306B is then added 312 to the result to obtain an overall slope value 314. Additionally, a similar process is completed for the final output intercept value 316, where the norm LUT 222 is multiplied with the Intercept_m_R value 306C and the result is added to Intercept_a_R 306D. Once obtained, the final output slope 314 value is multiplied 318 with the post-processed display data 207, and the final output intercept value 316 is added 320 to the result. These example calculations are presented below in Equations 1-3.

$$Slope = Slope\_ m \_ R * normLUT + Slope \_ a \_ R \qquad Eq . 1$$

$$Intercept = {Intercept}_{{m}_{R}} * normLUT + Slope\_ a \_ R \qquad Eq . 2$$

$$CompensatedOutput = Slope * PostProcessedData + Intercept \qquad Eq . 3$$

where Slope is the final output slope value 314, Intercept is the final output intercept value 316, CompensatedOutput is compensated data 209, and PostProcessedData is post-processed display data 207.

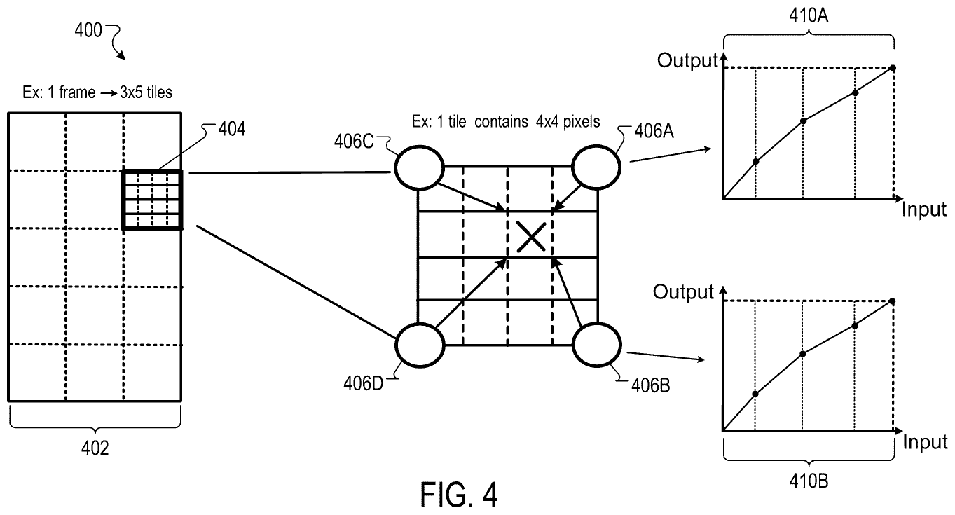

FIG. 4 shows an example framework 400 for obtaining pixel values used to render content on a display of a computing device. The framework 400 includes a frame 402 with multiple tiles 404. Each tile 404 includes multiple pixels (including example pixel 408) and four nodes 406A-D at each corner of the tile 404.

In some examples, nodes 406A-D are used as reference points for correction coefficient graphs 410A-B that describe the relationship between the input and output luminance from burn-in compensation at the node 406A-D. For example, node 406A can be associated with a correction coefficient graph 410A that describes the compensated display output for a given input. These inputs and outputs can be defined in terms of RGB values as discussed above (e.g., 256). While not depicted, nodes 406C-D have a corresponding correction coefficient graph similar to 410A-B.

In some examples, when evaluating the appropriate correction coefficients at any given pixel 408 within the tile 404, interpolation is performed considering the distance between the pixel 408 and nodes 406A-D, and the corresponding correction coefficients described by the nodes' correction coefficient graphs 410A-B. For example, for pixel 408 shown in FIG. 4, node 406A would have a more substantial impact on the resulting pixel 408 correction coefficient because of its closer proximity to pixel 408 when compared to another node (e.g., node 406D). Once resulting correction coefficient values are determined for pixel 408, these values can be used in the techniques described in the figures above and below (e.g., as correction coefficients 224 shown in FIG. 2).

In some examples, correction coefficient graphs 410A-B are divided into thresholds that each define a different relationship between the input and output (e.g., a different level of burn-in compensation). For example, correction coefficient graph 410A includes four separate thresholds, where each threshold can have a different ratio between input and output values. In some implementations, the multiplexer 304 encodes control/selection logic for the different thresholds of a tile or region and for selecting the appropriate correction coefficients for applying the burn-in compensation response to different intervals for different tiles and/or regions of a display. The division of correction coefficient graphs 410A-B into thresholds can be beneficial to account for the non-linear response of the human eye to luminance (e.g., lower luminance values may require additional burn-in compensation to be perceptible to a human viewer). Although only four thresholds are shown in FIG. 4, any number can be applied in practice.

FIG. 5 shows an example segmentation framework 500 for computing compensation control values to implement burn-in compensation at a display of system 100. In framework 500, example control (or segmentation) logic of system 100 can be used to divide an input range of display data for a tile into multiple intervals.

The input range of display data is obtained for a particular region of interest of the display. For example, the control logic 212 analyzes the display data for signs of burn-in and determines a particular region of interest for burn-in compensation based on the analysis. In some implementations, the control logic 212 analyzes parameters such as pixel output values, display temperature, and time duration for an active display session. The control logic 212 detects a region of interest for burn-in compensation when parameter values for the region exceed corresponding thresholds that are indicative of burn-in.

For example, the control logic 212 can determine that pixel output values indicating red luminance of 600 units have persisted for 2 hrs at a temperature of 45° C. The control logic 212 can identify the region of the display that includes these pixels as a region of interest that is indicative of burn-in effects that require compensation measures. The control logic 212 can then initiate operations for generating compensation control values 230 that are used to apply burn-in compensation to the particular region of interest on the display.

The control/segmentation logic identifies burn-in indicator values (e.g., norm LUTs) that quantify the relative degree of burn-in effect at the region of interest. Different sections or positions within the region of interest, or within the display overall, can exhibit different degrees of burn-in effect. In some implementations, segmentation logic of the hardware mechanism 205 processes an input range of display data, detects the different positions and corresponding degrees of burn-in effect within the display, and divides the input range of display data for each tile into multiple intervals. For instance, as shown in the example of FIG. 5, the coefficient graph 410 indicates that a collection of pixel values for a portion of display data can be divided to include at least interval 510 and interval 512.

For each of the multiple intervals, the control logic 212 identifies burn-in indicator values (e.g., norm LUTs) that quantify the relative degree of burn-in effect for that interval. The control logic 212 determines correction coefficients for each of the multiple intervals 510, 512 based on burn-in indicator values (e.g., norm LUTs) that quantify the relative degree of burn-in effect for that interval. For example, as shown at FIG. 5, the control logic can determine “Correction_Coeffs[3]” for interval 510. The control logic 212 can then generate a corresponding compensation line in accordance with correction coefficients for each of the multiple intervals. In some implementations, the control logic generates a piecewise linear compensation line by calculating the slope and intercept for each input interval (e.g., 510, 512) based on the corresponding correction coefficients. For example, the control logic 212 can generate a first compensation line 506 for a first interval and generate a second, different compensation line 508 for a second, different interval.

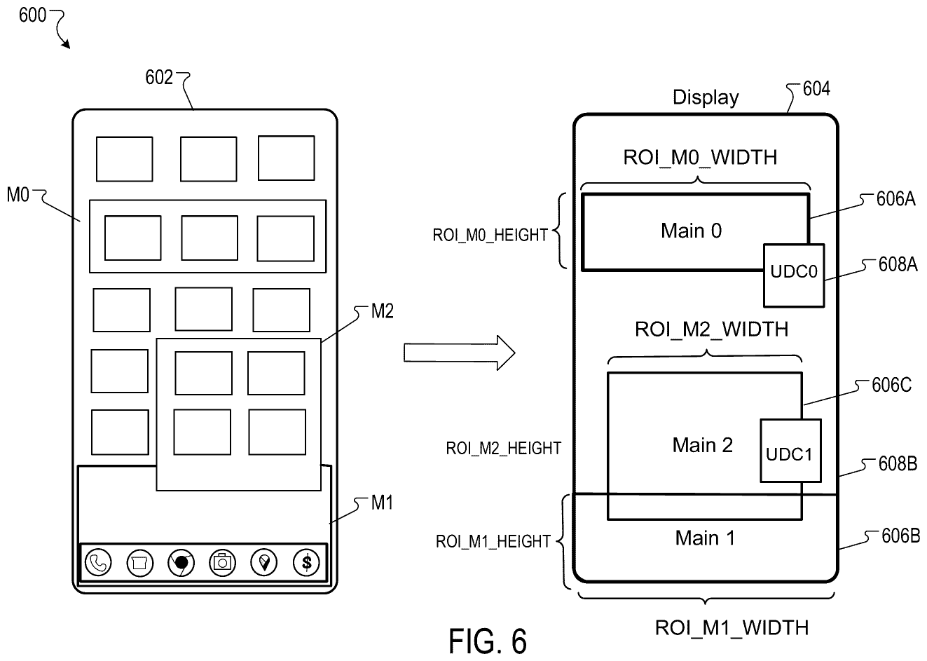

FIG. 6 shows example regions 600 of a display that can be identified for burn-in compensation. Included in FIG. 6 is an example of an uncompensated display 602 with block depictions of example regions M0, M1, and M2 of a display that may be identified or detected as suffering from burn-in. The control logic 212 of the RGB correction engine 208 (or burn-in control manager 108) can analyze pixel, time, and temperature values for the example regions M0, M1, and M2 and identify these example block depictions as regions of interest that indicate burn-in effects requiring compensation measures. FIG. 6 also includes multiple regions of interest (ROI) 606A-C, and multiple under display camera (UDC) regions 608A-B. In the implementation of FIG. 6, the example regions M0, M1, and M2 correspond to the ROIs 606A, 606B, 606C, respectively.

System 100 can be configured to assign ROIs to the display to reduce the bandwidth needed to perform burn-in compensation (e.g., ROIs 606A, 606B, 606C). For example, ROIs can be assigned to areas of the display that are more susceptible or prone to burn-in effects (e.g., common locations of icons, or an interface that is always displayed). As an example, ROI 606C in the uncompensated display 602 can correspond to a menu of icons that are typically displayed any time the display is lit. The continuous and/or persistent display of these menu icons can translate to pixel intensity, time, and temperature values that cause this area of the display to be identified as a region of interest that is particularly prone to display burn-in, and thus ROI 606C is assigned for this reason. Similar motivations apply to ROIs 606A and 606B. Although only three ROIs are shown, the total number of ROIs is not so limited, and other examples can include less or more ROIs when considering the prevalence of potential burn-in sources and processing efficiency.

Additionally, in some examples, each ROI can be assigned a UDC region (e.g., UDC 608A and 608B) to further control how burn-in compensation is applied. This increased control can be beneficial if the UDC region requires compensation at a different level of fidelity (e.g., 2×2 pixel tiles when compared to a typical 4×4 pixel tile). For example, UDC regions 608A and 608B on a display can have different luminance decay characteristics relative to the main regions (e.g., M0, M1, M2) of the display for the same pixel usage conditions. So, the control logic 212 can be configured to identify or detect pixel values corresponding to UDC regions 608A and 608B and compute and apply separate correction coefficients that are specific to the luminance decay characteristics of those UDC regions.

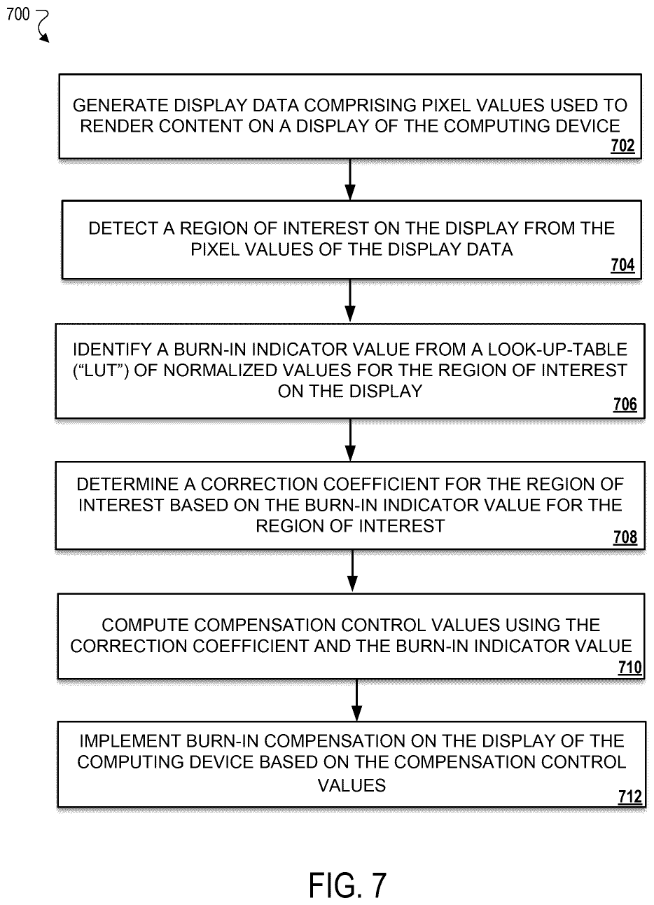

FIG. 7 is an example process 700 for executing burn-in compensation at a computing device.

Process 700 is also implemented or executed at system 100 using at least the display processing unit 116 of the display processing pipeline 200 described above with reference to FIG. 1. Hence, descriptions of process 700 will reference the above-mentioned computing resources of system 100. In some examples, the steps or actions of process 700 are enabled by programmed software instructions, firmware instructions, or both. Each type of instruction may be stored in a non-transitory machine-readable storage device and is executable by one or more of the processors or other resources described in this specification. In some implementations, the system 100 is a portion of hardware circuitry on an integrated circuit of a display processing unit along a display processing pipeline on the SoC.

Referring again to process 700, the system 100 generates display data that includes pixel values used to render content on a display of the device (702). For example, display data can represent the luminance of a display on a smartphone or laptop with a light-emitting diode (LED) or an organic LED (OLED) display. In some implementations, the display data is represented by values that quantify the luminance of a particular color, for example, R, G, B values. The display data can be generated based on accumulations of pixel luminance and brightness values obtained over a predefined time duration.

In some implementations, for each pixel in a set of display data, a respective pixel value for that pixel is determined as a function of the luminance at which the pixel is driven and the corresponding temperature within an area of the display that includes the relevant pixel. For example, a pixel can have a standard luminance pixel value as well as a temperature adjusted pixel value that is computed as a function of the standard luminance value and the corresponding temperature. The higher temperatures cause higher or accelerated the pixel usage estimates and correlate directly to higher instances of burn-in.

The system 100 detects a region of interest (ROI) on the display using the pixel values of the display (704). For example, an ROI can correspond to an area of the display that has experienced significant burn-in (e.g., common locations of icons, or an interface that is always displayed). In some implementations, an ROI is assigned to each area that is to undergo burn-in compensation, thus tailoring the compensation to only the required areas. By tailoring compensation to only ROIs, the overall processing requirements for burn-in compensation can be reduced.

The system 100 identifies a burn-in indicator value from a look-up-table (“LUT”) of normalized values for the region of interest on the display (706). For example, a discrete value (e.g., 0.5) can be applied to correction coefficients associated with the ROI to quantify the degree of burn-in and needed compensation. In some implementations, norm LUTs are a set of burn-in indicator values that are stored in DRAM and continuously updated as a display of system 100 ages. In some implementations, a burn-in indicator value is determined for each color channel in an R, G, B color channel of the region. The burn-in indicator value quantifies a degree of burn-in effect at a particular position within the region of interest on the display. In some implementations, the burn-in indicator indicates a relative severity of pixel degradation for a pixel at the particular position within the region of interest on the display.

The system 100 determines correction coefficients for the ROI based on the burn-in indicator value for the ROI (708). For example, correction coefficients can describe the relationship between the input and output luminance for a ROI and can be further divided into thresholds that describe specific luminance ranges. In some implementations, correction coefficients are mathematically combined with the burn-in indicator values to determine a needed level of burn-in compensation for the ROI. In some implementations, determining a respective correction coefficient for the ROI for each color channel in the R, G, B color channel of the region is based on the respective burn-in indicator value identified for the corresponding color channel in the R, G, B color channel of the region.

The system 100 computes compensation control values using the correction coefficients and the burn-in indicator value (710). For example, the correction coefficients can be reflected in a graph of input and output luminance that defines both a slope and an intercept value. In some implementations, the burn-in indicator values are multiplied with the slope associated with the graph of the correction coefficients for a particular ROI. A set of compensation control values can be computed for the ROI for each color channel in the R, G, B color channel of the region. For example, the compensation control values are computed based on the respective burn-in indicator value identified for the corresponding color channel in the R, G, B color channel of the region, and the respective correction coefficient determined for the corresponding color channel in the R, G, B color channel of the region.

The system 100 initiates and/or implements burn-in compensation at the display based on the compensation control values (712). For example, the burn-in compensation hardware 205 applies the compensation control values at an output stage of the display processing pipeline 200 to implement burn-in compensation on the display of the computing device. In some implementations, the compensation control values are applied to adjust the brightness or luminance of pixels associated with an OLED panel integrated in display hardware of the computing device.

In some implementations, the respective steps of process 700 are performed at a hardware integrated circuit as part of a larger compute operation to generate a machine-learning (ML) output, including an output for a neural network layer of a neural network that implements one or more ML models. For example, the output can be a portion of a computation for a ML task or inference workload to generate an image processing or image recognition output. A portion of the integrated circuit can include a special-purpose neural network processor or hardware ML accelerator configured to accelerate computations for generating and rendering different types of image processing outputs.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. For example, embodiments of the burn-in compensation hardware 205 and other subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. In some implementations, the computer storage medium corresponds to memory 106, memory device 122, or both.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them. In some implementations, the computing system encompasses processing devices of IP block 110, such as the ISP 112, HPU 114, DPU 116, and/or GPU 118.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification, including control logic of an example controller 212, can be performed by one or more programmable computers executing one or more computer programs to perform functions by operating on input data and generating output. For example, controller 212 and R/G/B correction engine 208 can be implemented as programmable computers executing one or more programs (e.g., control logic) to perform functions by operating on post-processed pixel input data 204 and generating outputs such as compensation control values 230. The processes and logic flows can also be performed by, and aspects of an example burn-in apparatus/mechanism can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. Some elements of a computer are a central processing unit for performing or executing instructions and one or more memory devices for storing instructions and data. Generally, a computer will also include, or be operatively coupled to receive data from or transfer data to, or both, one or more mass storage devices for storing data. However, a computer need not have such devices. Moreover, a computer can be embedded in another device, e.g., a mobile telephone, a personal digital assistant (PDA), a tablet device, a Smart television, a mobile audio or video player, or a game console, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., OLED display monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending data to and receiving data from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system 100 can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method implemented using a hardware burn-in compensation mechanism on a System-on-Chip (“SoC”) of a computing device, the method comprising:
generating display data comprising pixel values used to render content on a display of the computing device;
detecting a region of interest on the display from the pixel values of the display data;
identifying a burn-in indicator value from a look-up-table (“LUT”) of normalized values for the region of interest on the display;
determining a correction coefficient for the region of interest based on the burn-in indicator value for the region of interest;
computing compensation control values using the correction coefficient and the burn-in indicator value; and
applying the compensation control values to implement burn-in compensation on the display of the computing device.

2. The method of claim 1, wherein identifying a burn-in indicator value comprises, for the region of interest:
identifying a respective burn-in indicator value for each color channel in an R, G, B color channel of the region.

3. The method of claim 2, wherein determining a correction coefficient comprises, for the region of interest:
determining a respective correction coefficient for each color channel in the R, G, B color channel of the region is based on the respective burn-in indicator value identified for the corresponding color channel in the R, G, B color channel of the region.

4. The method of claim 2, wherein computing compensation control values comprises, for the region of interest, computing compensation control values for each color channel in the R, G, B color channel of the region based on the:
i) respective burn-in indicator value identified for the corresponding color channel in the R, G, B color channel of the region, and
ii) the respective correction coefficient determined for the corresponding color channel in the R, G, B color channel of the region.

5. The method of claim 1, the hardware burn-in compensation mechanism is represented by a portion of hardware circuitry on an integrated circuit of a display processing unit along a display processing pipeline on the SoC.

6. The method of claim 1, wherein the burn-in indicator value quantifies a degree of burn-in effect at a particular position within the region of interest on the display.

7. The method of claim 6, wherein the burn-in indicator indicates a relative severity of pixel degradation for a pixel at the particular position within the region of interest on the display.

8. The method of claim 1, wherein generating display data comprises:
generating display data based on accumulations of pixel luminance and brightness values obtained over a predefined time duration.

9. The method of claim 8, wherein detecting a region of interest on the display comprises:
detecting a region of interest on the display from pixel values that are determined as a function of a respective luminance of each pixel and a corresponding temperature at an area of the display that includes each pixel.

10. A System-on-Chip (“SoC”) for a computing device comprising:
a hardware burn-in compensation mechanism;
a processing device; and
a non-transitory machine-readable storage device storing instructions that are executable by the processing device to cause performance of operations comprising:
generating display data comprising pixel values used to render content on a display of the computing device;
detecting a region of interest on the display from the pixel values of the display data;
identifying a burn-in indicator value from a look-up-table (“LUT”) of normalized values for the region of interest on the display;
determining a correction coefficient for the region of interest based on the burn-in indicator value for the region of interest;
computing compensation control values using the correction coefficient and the burn-in indicator value; and
applying the compensation control values to implement burn-in compensation on the display of the computing device.

11. The SoC of claim 10, wherein identifying a burn-in indicator value comprises, for the region of interest:
identifying a respective burn-in indicator value for each color channel in an R, G, B color channel of the region.

12. The SoC of claim 11, wherein determining a correction coefficient comprises, for the region of interest:
determining a respective correction coefficient for each color channel in the R, G, B color channel of the region is based on the respective burn-in indicator value identified for the corresponding color channel in the R, G, B color channel of the region.

13. The SoC of claim 11, wherein computing compensation control values comprises, for the region of interest, computing compensation control values for each color channel in the R, G, B color channel of the region based on the:
i) respective burn-in indicator value identified for the corresponding color channel in the R, G, B color channel of the region, and
ii) the respective correction coefficient determined for the corresponding color channel in the R, G, B color channel of the region.

14. The SoC of claim 10, the hardware burn-in compensation mechanism is represented by a portion of hardware circuitry on an integrated circuit of a display processing unit along a display processing pipeline on the SoC.

15. The SoC of claim 10, wherein the burn-in indicator value quantifies a degree of burn-in effect at a particular position within the region of interest on the display.

16. The SoC of claim 15, wherein the burn-in indicator indicates a relative severity of pixel degradation for a pixel at the particular position within the region of interest on the display.

17. The SoC of claim 10, wherein generating display data comprises:
generating display data based on accumulations of pixel luminance and brightness values obtained over a predefined time duration.

18. The SoC of claim 17, wherein detecting a region of interest on the display comprises:
detecting a region of interest on the display from pixel values that are determined as a function of a respective luminance of each pixel and a corresponding temperature at an area of the display that includes each pixel.

19. A non-transitory machine-readable storage device storing instructions for implementing display operations using a hardware burn-in compensation mechanism on a System-on-Chip (“SoC”) of a computing device, the instructions being executable by a processing device to cause performance of operations comprising:
generating display data comprising pixel values used to render content on a display of the computing device;
detecting a region of interest on the display from the pixel values of the display data;
identifying a burn-in indicator value from a look-up-table (“LUT”) of normalized values for the region of interest on the display;
determining a correction coefficient for the region of interest based on the burn-in indicator value for the region of interest;
computing compensation control values using the correction coefficient and the burn-in indicator value; and
applying the compensation control values to implement burn-in compensation on the display of the computing device.

20. The machine-readable storage device of claim 19, wherein identifying a burn-in indicator value comprises, for the region of interest:
identifying a respective burn-in indicator value for each color channel in an R, G, B color channel of the region.
